(19) United States
(12) Patent Application Publication
(10) Pub. No.: US 2021/0369016 A1
(43) Pub. Date: Dec. 2, 2021

(54) Digital frame

(71) Applicant: Shenzhen Joyhong Technology Co., Ltd, Shenzhen (CN)

(72) Inventor: Jianping Wang, Shenzhen (CN)

(73) Assignee: Shenzhen Joyhong Technology Co., Ltd

(21) Appl. No.: 17/403,794

(22) Filed: Aug. 16, 2021

(51) Int. Cl. A47G 1/14; F16M 11/10; G09G 5/00

(52) U.S. Cl. CPC A47G 1/143; G09G 2380/16; G09G 5/00; F16M 11/105

(57) ABSTRACT

The invention relates to a narrow frame digital photo frame with multi-directional support function, including a photo frame body and a support. The back of the photo frame body is provided with a groove, the groove is arranged in a square, the support is provided with a boss with a square structure, and the boss is installed in the recess without gap. The narrow frame digital photo frame with multi-directional support function has design style of ultra narrow frame of the front shell. For the product with TP process as decorative edge, the matching boss can be installed on the photo frame in four directions by setting the groove of square structure, so as to realize the multi-directional placement angle of digital photo frame horizontally or vertically, Users can choose the placement angle of the bracket according to actual needs of browsing photos, so as to achieve best preview effect.

### TECHNICAL FIELD

The invention relates to the technical field of digital photo frame, in particular to a narrow frame digital photo frame with multi-directional support function.

### TECHNICAL BACKGROUND

With the continuous improvement of residents' economic level, many residents will go travel or have other activities, and there will be more photos sharing during their traveling. The traditional paper photo frame can not actually meet the existing use needs, so there is a digital photo frame with a stronger sense of science and technology. Among them, the digital photo frame is also a photo frame, but it is no longer displayed in the way of putting photos in, but through a LCD screen display, download the application app through the mobile phone, select the application function menu on the app, upload the photos to the cloud server, and download the photo frame locally through the cloud to realize the photo frame browsing function.

However, at present, the digital photo frame on the market usually adopts the fixed connection support rod to support the digital photo frame. It only has the support function in a single direction, can not realize the positioning support in any direction and is not convenient for disassembly, so it is inconvenient to some extent. At the same time, the product has no innovative style, including the old style of industrial design and institutional design. Without innovative characteristics, the buying point of the whole product can not be realized.

### The Invention Content

Based on this, it is necessary to add some innovative designs for the existing digital photo frame support structural design and the structural design of the front bottom shell, including industrial design.

In order to realize the purpose of the invention, the invention adopts the following technical solutions:

The narrow frame digital photo frame with multi-directional support function comprises a photo frame body and a support. The back of the photo frame body is provided with a groove, the groove is arranged in a square, the support is provided with a boss with a square structure, and the boss is installed in the groove without gap.

The narrow frame digital photo frame with multi-directional support function has the design style of ultra narrow frame of the front shell. For the product with TP process as the decorative edge, the matching boss can be installed on the photo frame body in four directions by setting the groove of square structure, so as to realize the multi-directional placement angle of digital photo frame horizontally or vertically, Users can choose the placement angle of the bracket according to the actual needs of browsing photos, so as to achieve the best preview effect.

In one embodiment, the photo frame body comprises a front shell and a bottom shell, and the middle square area of the bottom shell is assembled by pyramid shaped convex points with 3D effect and several square blocks.

In one embodiment, the four trapezoidal areas around the bottom shell adopt a water chestnut structure extending around.

In one embodiment, the front shell adopts an ultra narrow frame structure, and the chamfer of the front shell adopts a gold tracing effect process.

In one embodiment, the front shell has a square shape.

In one embodiment, the support angle between the support and the photo frame body is 15 degrees.

In one embodiment, the support is provided with a curved slope and an arc angle for forming a slope support.

In one embodiment, the interior of the support is provided with a stiffener structure, and the support is pasted with soft silicon to prevent crushing.

In one embodiment, the four end angles of the boss are arc chamfered.

### DESCRIPTION OF DRAWINGS

FIG. 1 is a schematic diagram of a narrow frame digital photo frame with multi-directional support function according to a preferred embodiment of the present invention;

FIG. 2 is another angle diagram of the narrow frame digital photo frame with multi-directional support function of FIG. 1;

FIG. 3 is a rear view of the photo frame body of FIG. 1;

FIG. 4 is a schematic diagram of the support of FIG. 1;

FIG. 5 is another angle diagram of the support of FIG. 1.

### DESCRIPTION OF ATTACHED DRAWING LABEL

100—Narrow frame digital photo frame with multi-directional support function;

### 10—The Digital Photo Frame

11—The groove

### 12—The Front Shell

13—Quadrilateral trapezoidal solar water chestnut,
14—Pyramid shape of 3D effect,

### 20—Support Stander,

### 21—Lug Boss,

22—strengthen Part.

### Specific Embodiments

In order to facilitate the understanding of the invention, the invention will be described more comprehensively below. However, the present invention can be implemented in many different forms and is not limited to the embodiments described herein. On the contrary, the purpose of providing these embodiments is to make a more thorough and comprehensive understanding of the disclosure of the present invention.

It should be noted that when an element is called “fixed to” another element, it can be directly on another element or there can be a centered element. When a component is considered to be “connected” to another component, it can be directly connected to another component or there may be intermediate components at the same time.

Unless otherwise defined, all technical and scientific terms used herein have the same meanings as those generally understood by those skilled in the technical field of the present invention. The terms used in the description of the invention herein are only for the purpose of describing specific embodiments and are not intended to limit the invention.

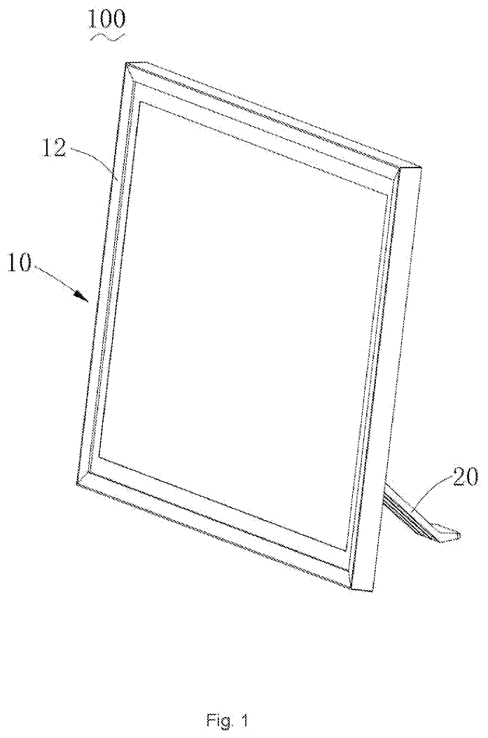

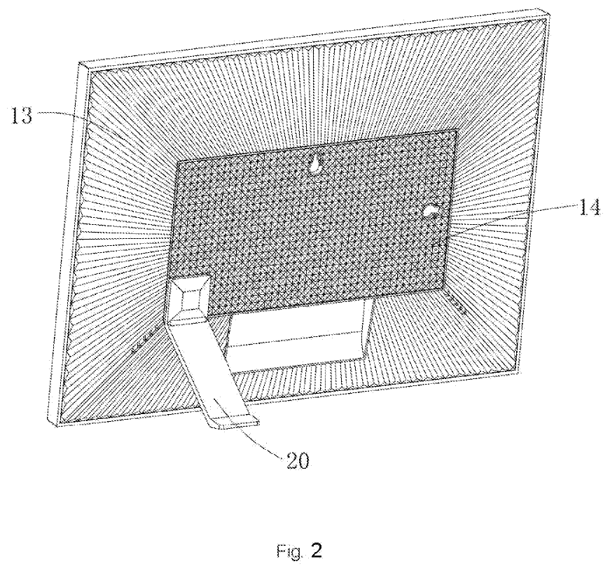

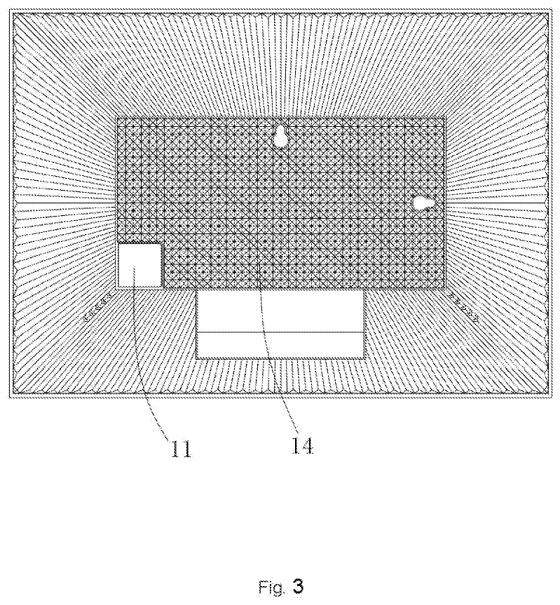

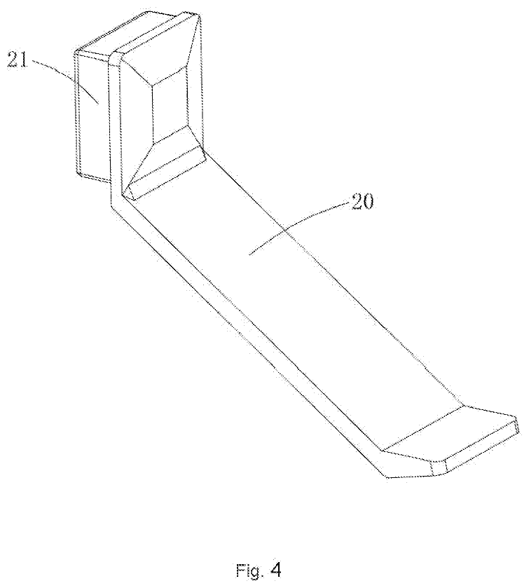

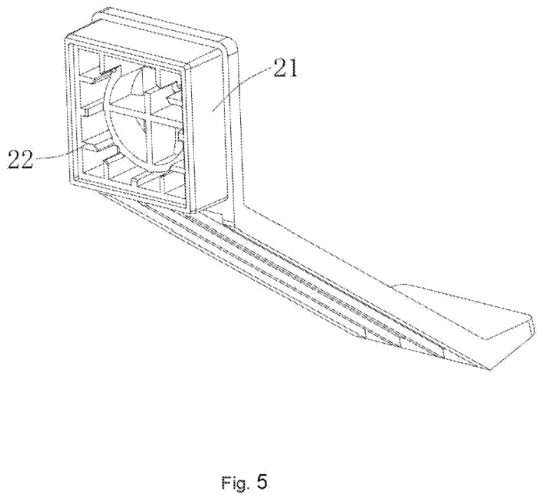

Referring to FIGS. 1 to 5, a narrow frame digital photo frame 100 with multi-directional support function according to a preferred embodiment of the present invention includes a photo frame body 10 and a support 20. The back of the photo frame body 10 is provided with a groove 11, the groove 11 is arranged in a square, the support 20 is provided with a boss 21 with a square structure, and the boss 21 is installed in the groove 11 without gap, Thus, the multi-directional support function of the support 20 to the photo frame body 10 is realized.

Further, the photo frame body 10 includes a front shell 12 and a bottom shell. The middle square area of the bottom shell is assembled by a pyramid shaped convex point with 3D effect and several square blocks, that is, the pyramid 14 with 3D effect, so as to form a square lattice structure. In this embodiment, the number of square blocks is 872; It can be understood that in other embodiments, the number of square blocks can be adjusted according to the size and use requirements of the bottom shell, so as to form display effects of different sizes.

Further, the four trapezoidal areas around the bottom shell adopt the water caltrop structure extending to the four sides, that is, the four trapezoidal solar water caltrop 13, which can produce a diffusion effect like the scattered light of the sun and promote a stronger sense of hierarchy of the whole bottom shell.

Further, the front shell 12 adopts the ultra narrow frame structure, the chamfer of the front shell 12 adopts the gold tracing effect process, and the TP decorative edge process is used for matching, so that the display area of the whole product is increased, the frame is narrower, and the matching perspective of the TP process is better.

Further, the front shell 12 has a square shape, which can highlight the water chestnut effect of the four angles of the front shell 12; At the same time, the front shell 12 and the bottom shell adopt the assembly method of the front shell wrapping the bottom shell, which is compact and the gap is more perfect.

Further, the support angle between the support 20 and the photo frame body 10 is 15 degrees, so as to realize the horizontal and vertical placement effects of the photo frame body 10.

Further, the support 20 is provided with a curved slope and an arc angle to form a slope support, so as to realize the slope support function of the support 20. The user can select the placement angle of the support according to the actual needs of browsing photos.

Further, the inner part of the support 20 is provided with a stiffener structure 22, and the support 20 is pasted with soft silicon to prevent crushing.

Further, the four end angles of the boss 21 are arc chamfered, so that the support zero gap matching bottom shell assembly is realized, and the combination of tightness is moderate.

The narrow frame digital photo frame with multi-directional support function has the design style of ultra narrow frame of the front shell. For the product with TP process as the decorative edge, the matching boss can be installed on the photo frame body in four directions by setting the groove of square structure, so as to realize the multi-directional placement angle of digital photo frame horizontally or vertically, Users can choose the placement angle of the bracket according to the actual needs of browsing photos, so as to achieve the best preview effect.

The technical features of the above embodiments can be combined arbitrarily. In order to make the description concise, all possible combinations of the technical features in the above embodiments are not described. However, as long as there is no contradiction in the combination of these technical features, it shall be considered to be the scope recorded in the specification.

The above embodiments only express several embodiments of the invention, and the description is more specific and detailed, but it cannot be understood as limiting the scope of invention patents. It should be noted that for those skilled in the art, several modifications and improvements can be made without departing from the concept of the invention, which belong to the protection scope of the invention. Therefore, the scope of protection of the patent of the invention shall be subject to the appended claims.

1. A narrow frame digital photo frame with multi-directional support function is characterized in that it comprises a photo frame body and a support, the back of the photo frame body is provided with a groove, the groove is arranged in a square, the support is provided with a boss of square structure, and the boss is installed in the groove without gap.

2. The narrow frame digital photo frame with multi-directional support function according to claim 1, which is characterized in that the photo frame body comprises a front shell and a bottom shell, and the middle square area of the bottom shell is assembled by pyramid shaped convex points with 3D effect and several square blocks.

3. The narrow frame digital photo frame with multi-directional support function according to claim 2, which is characterized in that the four trapezoidal areas around the bottom shell adopt a water chestnut structure extending around.

4. The narrow frame digital photo frame with multi-directional support function according to claim 2, which is characterized in that the front shell adopts an ultra narrow frame structure, and the chamfer of the front shell adopts a gold tracing effect process.

5. The narrow frame digital photo frame with multi-directional support function according to claim 2, which is characterized in that the front shell is in a square shape.

6. The narrow frame digital photo frame with multi-directional support function according to claim 1, which is characterized in that the support angle between the support and the photo frame body is 15 degrees.

7. The narrow frame digital photo frame with multi-directional support function according to claim 1, which is characterized in that the support is provided with a curved inclined plane and an arc angle to form a slope support.

8. The narrow frame digital photo frame with multi-directional support function according to claim 1, which is characterized in that a stiffener structure is arranged inside the support, and the support is pasted with soft silicon to prevent crushing.

9. The narrow frame digital photo frame with multi-directional support function according to claim 1, which is characterized in that the four end angles of the boss are arc chamfered.
